(19) United States
(12) Patent Application Publication
(10) Pub. No.: US 2015/0207364 A1
(43) Pub. Date: Jul. 23, 2015

(54) MICROWAVE ENERGY CONVERTER

(71) Applicant: SICHUAN UNIVERSITY, Chengdu (CN)

(72) Inventors: Kama HUANG, Chengdu (CN); Yang YANG, Chengdu (CN); Qian CHEN, Chengdu (CN); Changjun LIU, Chengdu (CN); Xing CHEN, Chengdu (CN); Qinggong GUO, Chengdu (CN); Liping YAN, Chengdu (CN); Xiang ZHAO, Chengdu (CN); Xiaoqing YANG, Chengdu (CN)

(21) Appl. No.: 14/672,218

(22) Filed: Mar. 29, 2015

Related U.S. Application Data
(63) Continuation-in-part of application No. PCT/CN2013/071366, filed on Feb. 5, 2013.

(30) Foreign Application Priority Data
Dec. 7, 2012 (CN) 201210521544.3

(51) Int. Cl. H02J 17/00

(52) U.S. Cl. CPC H02J 17/00

(57) ABSTRACT

A microwave energy converter, including at least one semiconductor and ohmic contact electrodes. The semiconductor acts as both a microwave receiving unit and a microwave rectifying unit of the microwave energy converter. The ohmic contact electrodes are disposed at two ends of the semiconductor along a microwave transmission direction to output direct current generated by the semiconductor.

### CROSS-REFERENCE TO RELATED APPLICATIONS

This application is a continuation-in-part of International Patent Application No. PCT/CN2013/071366 with an international filing date of Feb. 5, 2013, designating the United States, now pending, and further claims priority benefits to Chinese Patent Application No. 201210521544.3 filed Dec. 7, 2012. The contents of all of the aforementioned applications, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, Cambridge, Mass. 02142.

### BACKGROUND OF THE INVENTION

1. Field of the Invention

The invention relates to a microwave energy converter.

2. Description of the Related Art

Typically, the microwave rectification technology involves a microwave diode. However, the microwave diode has low power capacity and is easy to break down and thus produces higher harmonics, so the rectification performance is poor. In addition, as far as existing diode rectification antenna is concerned, the microwave receiving antenna and microwave rectification circuit are independent from each other, and thus, to enable the rectification circuit to match the antenna and inhibit the production of higher harmonic, the rectification circuit must be designed with a complex structure. As a result, the design is relatively difficult and costly, and the weight and size of the antenna are difficult to control.

### SUMMARY OF THE INVENTION

In view of the above existing problems in the prior art, it is one objective of the invention to provide a microwave energy converter that is easy to design and has a simple structure.

To achieve the above objective, in accordance with one embodiment of the invention, there is provided a microwave energy converter comprising at least one semiconductor and ohmic contact electrodes. The semiconductor acts as both a microwave receiving unit and a microwave rectifying unit of the microwave energy converter; the ohmic contact electrodes are disposed at two ends of the semiconductor along a microwave transmission direction to output direct current generated by the semiconductor.

Based on the principle of the microwave Hall effect and semiconductor bulk effect, the invention provides a microwave rectification method, which is also called a semiconductor bulk effect-based microwave rectification method. The method is totally different from conventional diode junction effect-based microwave rectification principle. Using the method, a rectification effect is achieved on a semiconductor according to the microwave Hall effect, no need to design an antenna and circuit, and the microwave receiving and rectifying are simultaneously completed in one semiconductor.

Studies show that, in the absence of external magnetic field, the radiation of the microwave on a semiconductor can produce the Hall effect, and thus a DC voltage is generated on the semiconductor along the direction of the Poynting vector (the microwave transmission direction). Based on the principle, the microwave rectification can be achieved. In the invention, a current having the same direction as the electric field is induced in a unipolar (P-type or E-type) semiconductor under the action of the electric field component of a plane wave, and the charger carrier forming the current is affected by the lorentz force along the direction of the Poynting vector under the action of the magnetic field component of the plane wave. As a result, a Hall voltage is generated in the semiconductor along the direction of the Poynting vector. When the electric field and the magnetic field are reverse simultaneously, the direction of the lorentz force is unchanged, so is the direction of the Hall voltage. Thus, a sustained DC voltage is generated between two ends of the semiconductor along the direction of the Poynting vector. On the basis of the above mentioned principle, the microwave receiving and rectifying are simultaneously achieved by the same semiconductor, so the conventional antenna and circuit can be ignored, thereby greatly simplifying the design, reducing the product costs, and the volume and weight of the microwave energy converter are easy to control.

In a class of this embodiment, the ohmic contact electrodes are a metal electrode.

In a class of this embodiment, the metal electrode is prepared using a sputtering process or coating process.

The ohmic contact electrodes disposed on two ends of the semiconductor are connected by conducting wires so as to output the direct current generated by the semiconductors. In general, the ohmic contact electrodes are a metal electrode. By means of sputtering process or coating process, a metal material is coated on two ends of the semiconductor along the direction of the Poynting vector to form the ohmic contact electrodes.

In a class of this embodiment, the semiconductor is an intrinsic semiconductor.

In a class of this embodiment, the semiconductor is a doped semiconductor.

The semiconductor can be either an intrinsic semiconductor or a doped semiconductor. The application of the doped semiconductor can increase the concentration of the charge carrier of the semiconductor, thereby improving the rectification efficiency. With the increase of the doping concentration, the properties of the semiconductor vary; specifically, the semiconductor tends to exhibit the characteristics of a metal conductor. Thus, highly doped semiconductor cannot improve but does reduce the rectification efficiency.

In a class of this embodiment, the microwave energy converter comprises N semiconductors having the same structure, where N is a positive integer greater than or equal to 2; the ohmic contact electrodes are connected by conducting wires so that the direct current generated by the semiconductors is output in parallel or in series.

Since the Hall voltage and current generated by a single semiconductor are very small, a plurality of semiconductors can be provided and connected in series to increase the output voltage, or a plurality of semiconductors are provided and connected in parallel to increase the output current. The involved semiconductors have the same structures so that the circuit parameters, the generated voltages and current are basically the same, which benefits the subsequent connection and treatment, for example, inverting and connection to grid.

In a class of this embodiment, the semiconductors are disposed on one plane.

In a class of this embodiment, the plane is perpendicular to the microwave transmission direction.

That the N semiconductors are disposed on the same plane (or plate) and that the plane is perpendicular to the microwave transmission direction can improve the microwave energy conversion efficiency and receive the microwave energy to the greatest extent. Optionally, the N semiconductors can also be disposed on the surface of an uneven object, for example, on the surface of a flying vehicle, to receive the microwave energy from a launch station.

In a class of this embodiment, the semiconductors are evenly disposed on M planes, and M is a positive integer greater than or equal to 2.

If N is super large, the semiconductors can be evenly disposed on Mplanes. Since the semiconductors have the same structure, the same number of semiconductors is disposed on each plane, and the semiconductors are connected in the same mode, the circuit structure, the output voltage and current are basically the same. Thus, each plane can be regarded as a basic unit and connected in parallel or in series, to meet the requirement for outputting different voltage or current values.

In a class of this embodiment, the planes are disposed side by side or are overlapped in parallel.

The M planes can be disposed side by side and are perpendicular to the microwave transmission direction, and thus the planes have no interference with one another, thereby improving the energy conversion efficiency. When the M planar plates are overlapped in parallel, considering the attenuation of the microwave, the plates should be made of materials having low attenuation and loss against microwave. In addition, the metal electrode on the semiconductor may impede the microwave transmission, so the area of the metal electrode should be small as needed.

Advantages according to embodiments of the invention are summarized as follows. The microwave energy converter can both receive microwave and rectify the microwave, thereby greatly simplifying the circuit design. The semiconductors can be disposed and connected in different modes, thereby meeting the requirement for outputting different voltage or current values. The microwave energy converter has a simple structure and a relatively wide rectification bandwidth. The rectification of the invention is independent on PN junction, so large power microwave can be received without the occurrence of breakdown. As a result, the microwave energy converter is highly reliable.

### BRIEF DESCRIPTION OF THE DRAWINGS

FIG. 1A is a schematic diagram of microwave transmission; FIG. 1B is a schematic diagram of the production of a hall voltage in a semiconductor;

FIG. 2 is a schematic diagram of outputting a voltage from semiconductors connected in parallel;

FIG. 3 is a schematic diagram of outputting a voltage from semiconductors connected in series;

FIG. 4 is a schematic diagram showing N semiconductors arranged in the same plane;

FIG. 5A is a stereograph of a semiconductor; FIG. 5B is cross sectional view of FIG. 5A taken from line A-A;

FIG. 6 shows N evenly disposed semiconductors on four planes side by side; and

FIG. 7 shows N evenly disposed semiconductors on four overlapped planes.

### DETAILED DESCRIPTION OF THE EMBODIMENTS

For further illustrating the invention, experiments detailing a microwave energy converter are described below. It should be noted that the following examples are intended to describe and not to limit the invention.

In the invention, when microwave directly radiates a semiconductor of a microwave energy converter, according to the Hall effect, a direct current voltage will be generated in the semiconductor along the Poynting vector direction (i. e., microwave transmission direction).

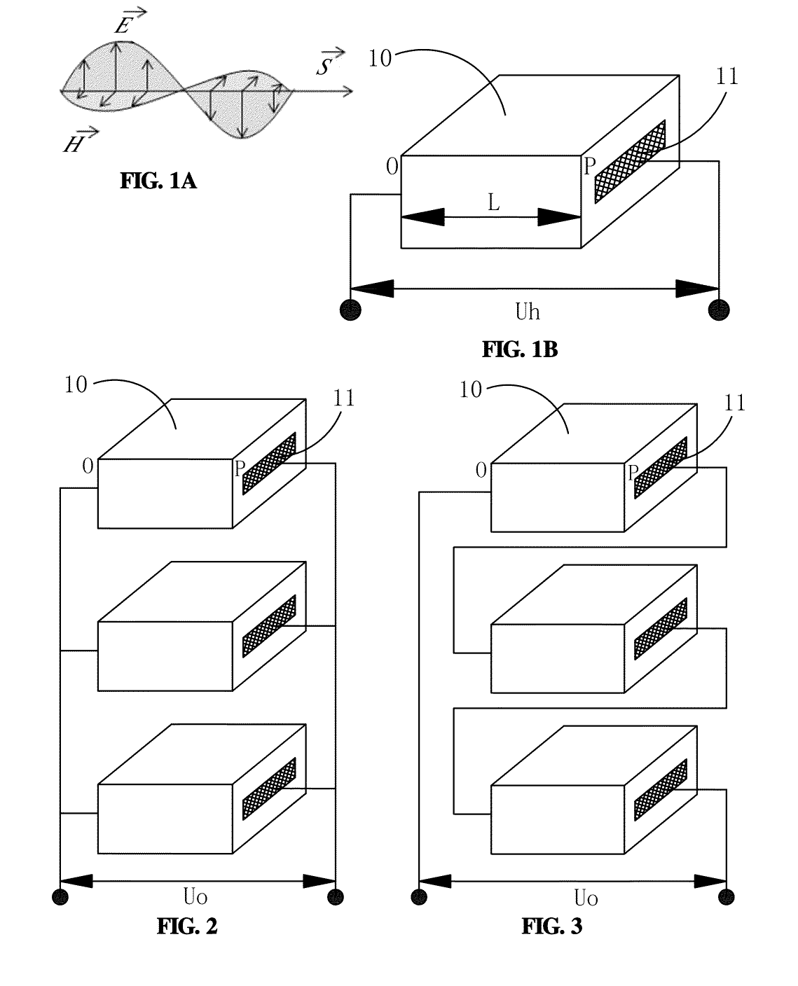

The microwave energy converter comprises at least one semiconductor 10 and ohmic contact electrodes 11. The semiconductor acts as both a microwave receiving unit and a microwave rectifying unit of the microwave energy converter. The ohmic contact electrodes are disposed at two ends of the semiconductor along a microwave transmission direction to output direct current generated by the semiconductor. When microwave radiates the semiconductor 10 of the microwave energy converter, a Hall voltage will be generated between an O end and a P end of the semiconductor along the microwave transmission direction. As shown in FIG. 1A, \vec{S} is Poynting vector, which represents the microwave transmission direction; \vec{E} is an electric field component, and \vec{H} is a magnetic field component. In FIG. 1B, Uh represents a Hall voltage generated by the semiconductor, i.e., the microwave rectifying voltage.

In the invention, a current is induced in a unipolar semiconductor under the action of the electric field component of a plane wave, and the charger carrier forming the current is affected by the lorentz force along the direction of the Poynting vector under the action of the magnetic field component of the plane wave. As a result, a Hall voltage is generated in the semiconductor along the direction of the Poynting vector. When the electric field and the magnetic field are reverse simultaneously, the direction of the lorentz force is unchanged, so is the direction of the Hall voltage. Thus, a sustained DC voltage is generated between two ends of the semiconductor along the direction of the Poynting vector.

The semiconductor is an intrinsic semiconductor or a doped semiconductor. The application of the doped semiconductor can increase the concentration of the charge carrier of the semiconductor, thereby improving the rectification efficiency. With the increase of the doping concentration, the properties of the semiconductor vary; specifically, the semiconductor tends to exhibit the characteristics of a metal conductor. Thus, highly doped semiconductor will increase the microwave loss, thereby reducing the rectification efficiency. In addition, the length of the semiconductor along the direction of the Poynting vector (the length L between two electrodes in FIG. 1) also affects the rectification efficiency. The larger the length, the higher the rectification efficiency. However, when the length L reaches a value larger than a skin depth of microwave, the increase of the length cannot improve the rectification efficiency any more.

The ohmic contact electrodes 11 disposed on the two ends of the semiconductor 10 are connected by conducting wires so as to output the direct current generated by the semiconductors. In general, the ohmic contact electrodes 11 are a metal electrode. By means of sputtering process or coating process, a metal material is coated on the two ends of the semiconductor along the direction of the Poynting vector to form the ohmic contact electrodes 11.

### EXAMPLE 1

In this example, the microwave energy converter comprises three semiconductors 10 having the same structure (that is, the same constituent materials and the same geometric dimensioning). The ohmic contact electrodes are connected by conducting wires. In FIG. 2, the semiconductors are connected in parallel. The current generated by the three semiconductors is output in parallel. The output voltage is Uo=Uh, and the output current is three times as much as that generated by a single semiconductor. In FIG. 3, the semiconductors are connected in series, in which, the output voltage is Uo=3 Uh, and the output current is equal to that generated by a single semiconductor.

### EXAMPLE 2

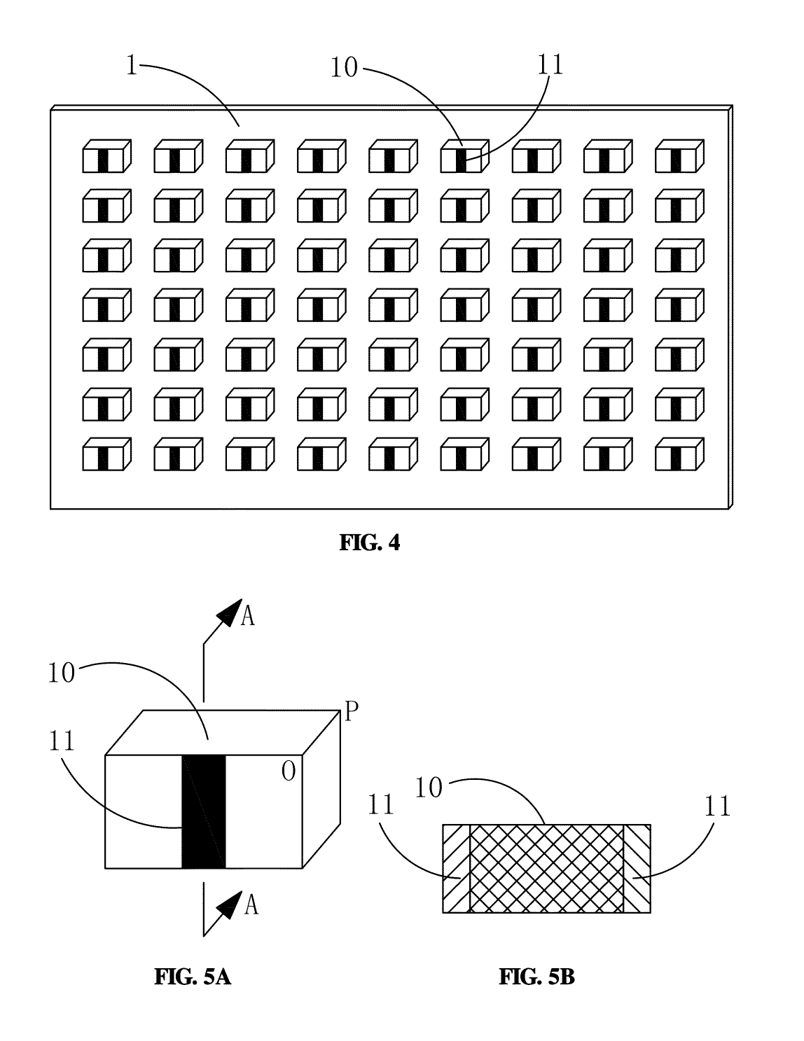

Since the Hall voltage and current generated by a single semiconductor are very small, a plurality of semiconductors can be provided and connected in series to increase the output voltage, or are connected in parallel to increase the output current. The involved semiconductors have the same structures so that the circuit parameters, the generated voltages and current are basically the same, which benefits the subsequent connection and treatment. In this example, the microwave energy converter comprises N (N=63) semiconductors having the same structures which act as both a microwave receiving unit and a microwave rectifying unit, as shown in FIG. 4. The 63 semiconductors 10 are evenly distributed on one planar plate 1 to form a 7×9 array. To improve the receiving efficiency of microwave, the planar plate 1 directly faces the microwave transmission direction (the planar plate is perpendicular to the microwave transmission direction). The O end of the P end of the semiconductors 10 are two ends along the microwave transmission direction. The ohmic contact electrodes are disposed at the O end of the P end of the semiconductors 10 to output the current generated by the semiconductors 10, as shown in FIG. 5. In FIG. 4, the ohmic contact electrodes of the semiconductors in each row are first connected in series, and then the rows are connected in parallel. As a result, the total output voltage generated by the semiconductors in the planar plate 1 can reach 9 Uh, and the total current can be seven times that generated by a single semiconductor.

### EXAMPLE 3

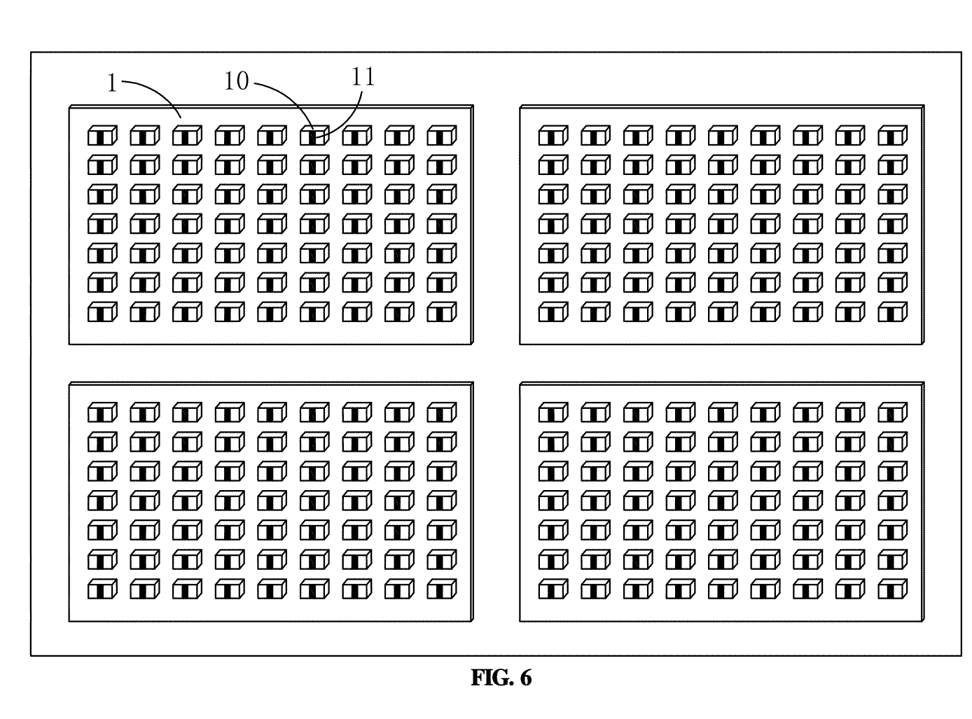

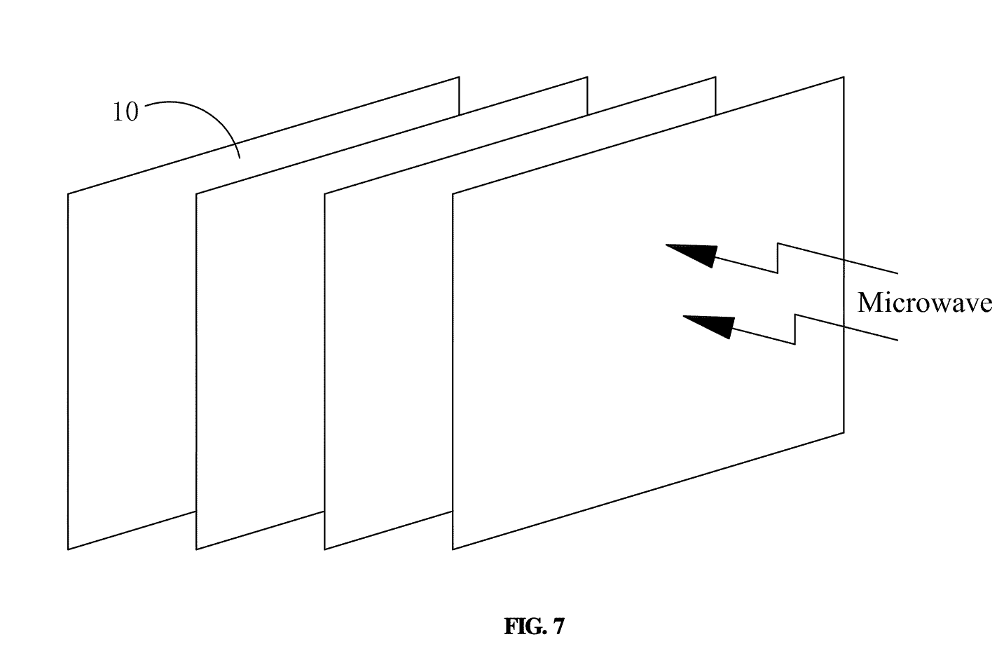

The microwave energy converter comprises 252 semiconductors which are evenly distributed on four planar plates arranged side by side, with each planar plate comprising 63 semiconductors in a 7×9 array, as shown in FIG. 6. The arrangement mode greatly improves the receiving area of the microwave radiation. The semiconductors in each planar plate can be connected according to the mode in Example 2, and then the four planar plates are combined in series or in parallel, so as to output a desired voltage and current.

### EXAMPLE 4

As shown in FIG. 7, four planar plates are overlapped in parallel (the semiconductors are not shown, and the thickness of the planar plates is not considered). The four planar plates are parallel to one another with a certain interval. The arrow represents the microwave transmission direction which is perpendicular to the plate plane. The arrangement can improve the availability ratio of the microwave, but the penetrability of the microwave should be considered, so as not to affect the conversion rate of microwave of lower plates. Thus, the plates are preferably made of materials having low attenuation and loss against microwave, and the area of the ohmic contact electrodes should be not very large. Basically, when the dimension of the metal electrode is much less than the microwave wavelength, the transmission of the microwave will be unaffected.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A microwave energy converter, comprising at least one semiconductor and ohmic contact electrodes, wherein the semiconductor acts as both a microwave receiving unit and a microwave rectifying unit of the microwave energy converter; the ohmic contact electrodes are disposed at two ends of the semiconductor along a microwave transmission direction to output direct current generated by the semiconductor.

2. The converter of claim 1, wherein the ohmic contact electrodes are a metal electrode.

3. The converter of claim 2, wherein the metal electrode is prepared using a sputtering process or coating process.

4. The converter of claim 1, wherein the semiconductor is an intrinsic semiconductor.

5. The converter of claim 1, wherein the semiconductor is a doped semiconductor.

6. The converter of claim 1, comprising N semiconductors having the same structure, wherein N is a positive integer greater than or equal to 2; the ohmic contact electrodes are connected by conducting wires and the direct current generated by the semiconductors is output in parallel or in series.

7. The converter of claim 6, wherein the semiconductors are disposed on one plane.

8. The converter of claim 7, wherein the plane is perpendicular to the microwave transmission direction.

9. The converter of claim 6, wherein the semiconductors are evenly disposed on M planes, and M is a positive integer greater than or equal to 2.

10. The converter of claim 9, wherein the planes are disposed side by side or are overlapping.
